(19) United States
(12) Patent Application Publication
(10) Pub. No.: US 2008/0046726 A1
(43) Pub. Date: Feb. 21, 2008

(54) Assessing a community of particle capability

(75) Inventors: Deborah Louise Dunagan, Gainesville, GA (US); Cheryl Diane Jetmund, West Tisbury, MA (US); Louisa Josephine Peluso, Atlanta, GA (US); Gloria M. Ron-Fornes, Summit, NJ (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/501,660

(22) Filed: Aug. 8, 2006

(51) Int. Cl. H04L 9/00

(52) U.S. Cl. 713/167

(57) ABSTRACT

The capability level of a community of practice is assessed. A community model is provided having key areas of focus each defined by levels. The levels have attributes. The community is compared to the attributes in the model to determine community levels for all key areas of focus. Individual community levels are then combined to assess the community capability.

### TECHNICAL FIELD

The invention relates to a community of practice and particularly to a method and system for assessing the capability level of a community of practice. Even more particularly, the invention relates to use of a community model in the capability assessment.

### BACKGROUND OF THE INVENTION

In today's knowledge economy, knowledge workers in an organization add to their own capabilities by interacting with other workers on topics and ideas on a day-to-day basis. Although such interactions have always occurred in the past, recent technological developments in collaboration tools, such as team rooms, instant messaging, inexpensive worldwide telecommunications and the like, have increased their extent and frequency by orders of magnitude. The formation of communities of practice follows naturally from such interactions.

Communities of practice have been described by Etienne Wenger et al. in their book titled Cultivating Communities of Practice, Harvard Business School Press, 2002. Gongla and Rizzuto also describe some experience with communities of practice within the IBM company's Global Services organization in their paper titled, “Evolving Communities of Practice: IBM Global Services Experience” published in the IBM Systems Journal, volume 40, no. 4, 2001, pages 842-862. The Wenger book, chapter 8, “Measuring and Managing Value Creation”, pages 161-185, and Gongla article shall be incorporated herein by reference in their entireties. As used herein, a community of practice shall be taken to mean a collection of individuals bound by informal relationships, that share similar work roles and a common subject matter interest. For example, the individuals may all be employees of a single, large company, but located at various dispersed geographical sites and reporting to a diverse number of functional areas/divisions of the company. Companies recognize the importance of communities of practice and encourage their formation and development to benefit both the individuals and the company.

It is natural, therefore, for the companies to want to measure the effectiveness of such communities. However, because of their informal and flexible nature, with individuals often joining or leaving the community at will with no direct company involvement, measurement has been difficult to accomplish.

Gongla describes an evolution model describing how communities transform themselves at each of five stages. He also describes the fundamental function for each of these stages. After outlining this model, a team examined a fairly large number of communities to classify these by framework element according to these stages. The examination consisted of:

health checks

annual strategic and operational planning

enabling technology evolutions

process improvement activities.

The scores for the communities were grouped by company line-of-business (LOB).

Despite this early work by Gongla, there remains a desire for an improved method of community capability assessment.

### OBJECTS AND SUMMARY OF THE INVENTION

It is therefore a principal object of the present invention to enhance the community of practice art by providing a method of assessing a community of practice capability.

It is a further object to provide such a method which can be performed in a relatively inexpensive manner and which is adapted for use within large organizations.

It is yet another object to provide a system for performing such an assessment.

These and other objects are attained in accordance with one embodiment of the invention wherein there is provided a method of assessing a community of practice capability, comprising the steps of, providing a community of practice, of individuals, providing a community model having key areas of focus wherein each key area of focus, is defined by levels, each level having attributes, for each key area of focus, comparing said community of individuals to the attributes to determine a community level for that key area of focus, and combining the community levels to assess the community capability.

In accordance with another embodiment of the invention, there is provided a system for assessing a community of practice capability, comprising, a community of practice, of individuals, a community model having key areas of focus wherein each key area of focus is defined by levels, each level having attributes, for each key area of focus, means for comparing the community of individuals to the attributes to determine a community level for that key area of focus, and means for combining the community levels to assess the community capability.

### BRIEF DESCRIPTION OF THE DRAWINGS

FIG. 1 is a flowchart depicting a method of assessing a community of practice capability;

FIGS. 2, 3, and 4 are key areas of focus defining levels having attributes; and

FIG. 5 is a system diagram of a system for assessing a community of practice capability in accordance with the present invention.

### BEST MODE FOR CARRYING OUT THE INVENTION

In a better understanding of the present invention, together with other and further objects, advantages and capabilities thereof, reference is made to the following disclosure and the appended claims in connection with the above-described drawings.

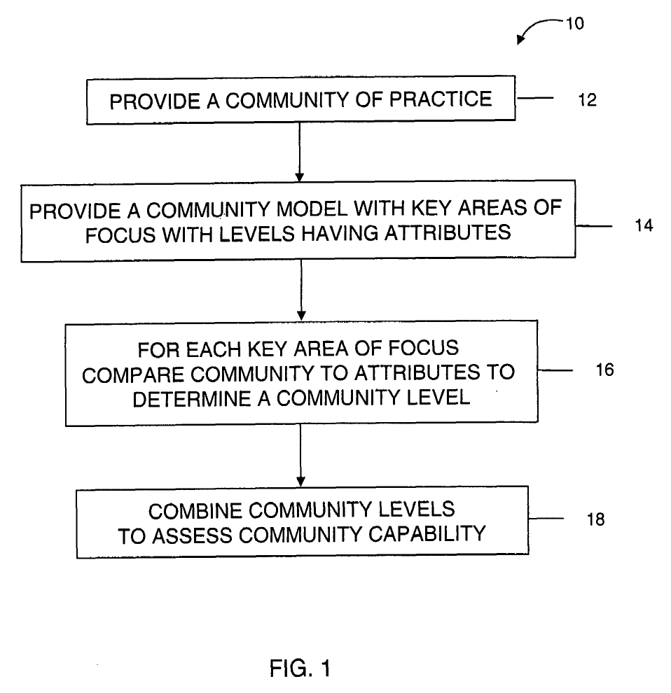

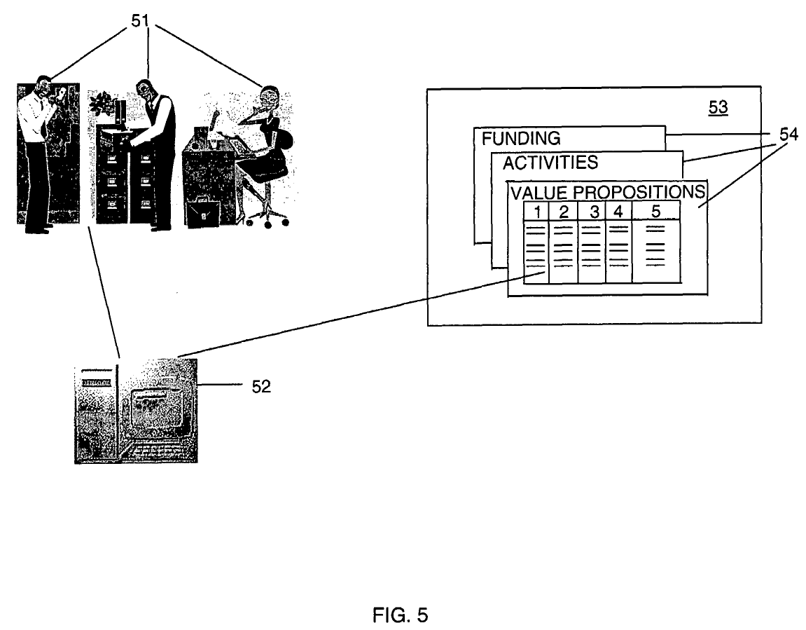

In FIG. 1, there is shown a flowchart 10 for a method of assessing a community of practice capability in accordance with the present invention. In step 12, a community of practice is provided. The community comprises individuals as defined above. For example, the community shown in FIG. 5 comprises two male and one female individuals 51. The community of practice may be formed in any way, whether encouraged by an employer or not.

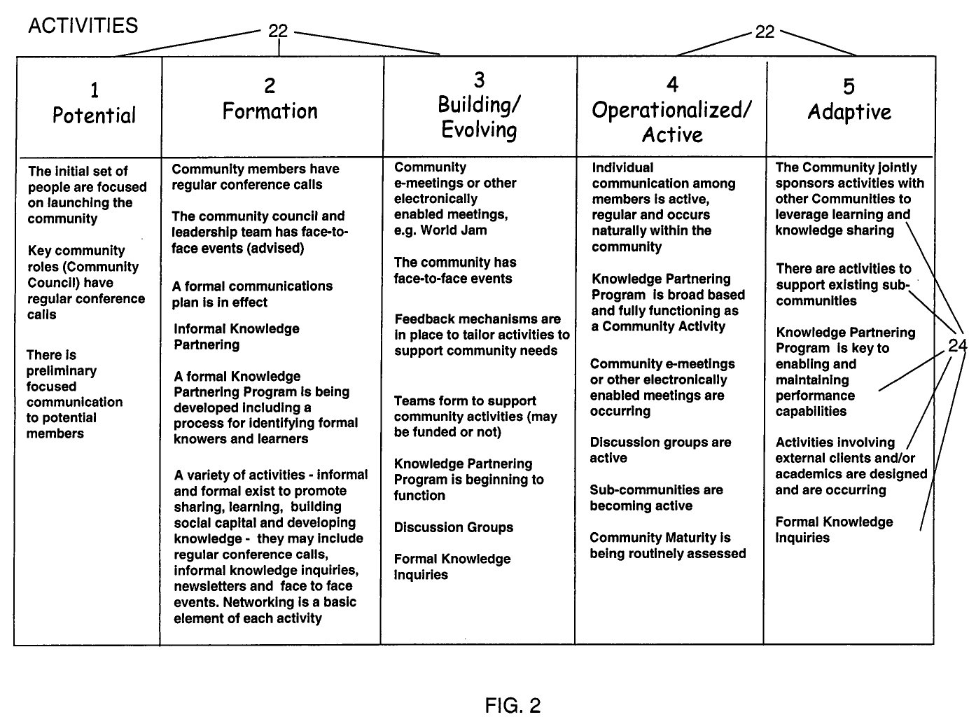

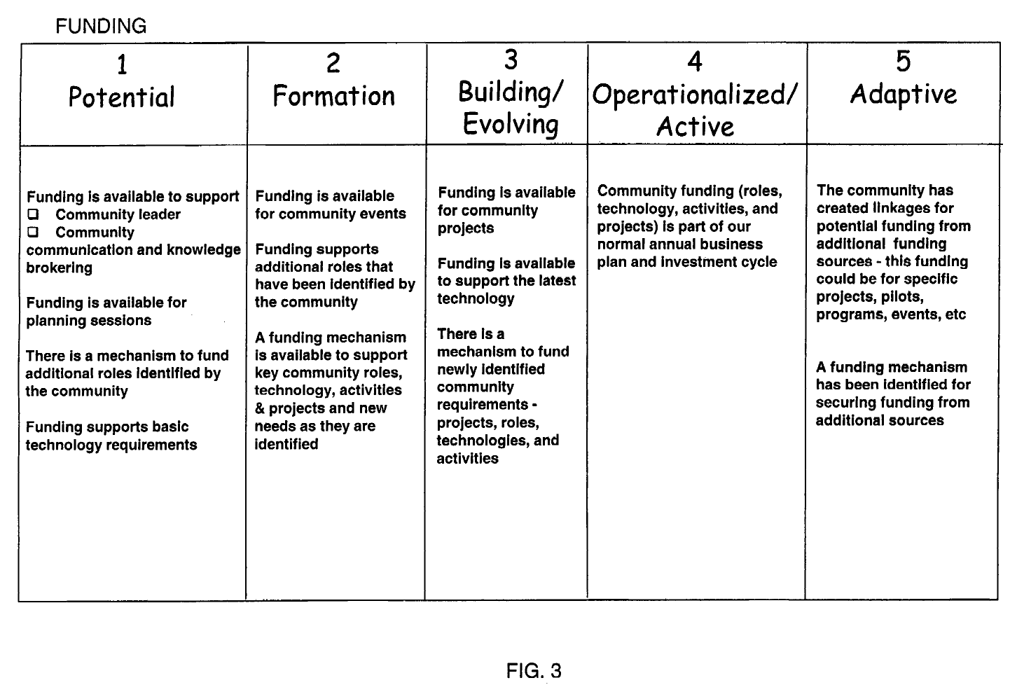

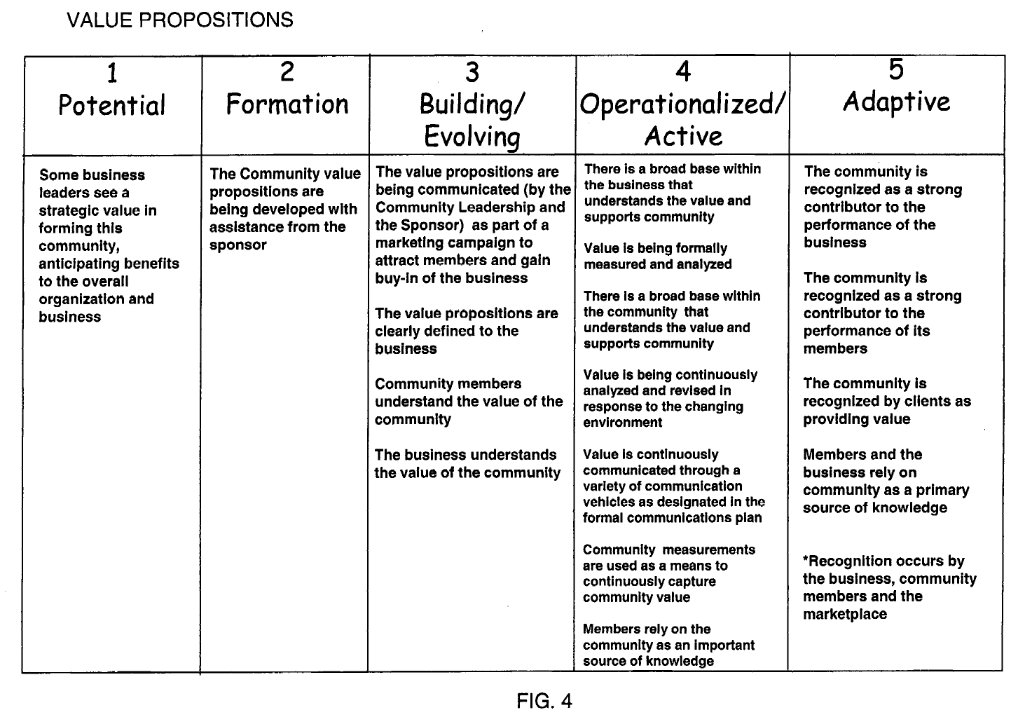

In step 14, a model of the community is provided. The model has key areas of focus specified. For example, FIGS. 2, 3, and 4 specify the key areas of focus of activities, funding, and value propositions respectively. Other key areas of focus may be:

sponsorship

community roles and responsibilities

membership

meaning and mastery

organizational memory

technology

social capital

measurements

incentives

vision, mission, goals

Gongla uses the term “framework element” to describe concepts which are similar to the above key areas of focus. Each key areas of focus is defined by levels. The levels correspond somewhat to Gongla's stages. In FIGS. 2, 3, and 4, there are five levels 22 designated as potential, formation, building/evolving, operationalized/active, and adaptive. In this case, the higher levels denote a more advanced development and a higher capability for that key area of focus. At the potential level the community begins to emerge around subject matter experts, or a sponsor or leader is selected to engage a core team of subject matter experts. At the formation level, other members discover the community and join because they have identified value in participating, or other members are invited and additional subject matter experts are sought out. At the building/evolving level, the community has begun to stabilize around formal processes, policies, and norms. At the operationalized/activated level, the community is well established and is a recognized part of the organization from which the members are drawn. At the adaptive level, the community is demonstrating optimal value to its members and to the organization. It provides highly evolved sense and respond capabilities. At this level, the community focuses on specializing or subdividing to address more granular goals.

In the community model, each level 22 for each key area of focus has attributes 24. The attributes characterize the levels for the key areas of focus.

In step 16, the present community of individuals is compared to the attributes in the model for each key area of focus to determine a level for the community for that particular key area of focus. A level may be determined, for example, because the attributes for that level all match the present community of individuals and no other attributes for any other levels match the present community. However, it is often the case that not all the attributes for one level match the community or that some attributes for one level match, but one or more attributes for another level also match, so a single integer level is not directly determined.

Other methods of determining a level for a particular key area of focus may be used. For example, the level may be determined to be that level having the highest percentage of matches for the attributes for that model level. A weighted average may be computed based on the matching attributes at each level. In that case, a non-integer level may result. A non-integer level may be selected between the two highest percentage match levels. The value selected may have the same ratio between the integer values as the ratio of percentage matches. That is, the value will be closer to the level having the higher percentage attribute match.

Once a level is determined in step 16 for a community for each key area of focus, the levels are combined in step 18 to assess the community capability. Various methods of combining individual scores as are known in the scoring arts may be used. For example, the individual level scores may be combined as a weighted average. Weighting values may be selected based on the relative importance of each key area of focus. Weighting values may also be selected based on historical learning or on any other method known in the art.

FIGS. 2, 3, and 4 are examples and not intended to be limiting of attributes for three key areas of focus of a community of practice model.

FIG. 5 shows the elements of a system for assessing a community of practice capability. The system includes a community of practice of individuals 51. Community model 53 has a plurality of key areas of focus 54. Each key area of focus in the model is defined by levels 22 with each level having attributes 24.

The system has means 52 for comparing the community of practice to the attributes in the model. Means for comparing may comprise a computer. The computer may be programmed to store model 53 and display the attributes for a key area of focus on a display screen. One or more individuals familiar with the community may then enter via an entry device such as keyboard, mouse, or other pointing device, an indication of whether an attribute matches the community. The entering individual may be a member of the community; however, this is not required. Some other individual familiar with the community in at least one key area of focus may enter matching data for that key area.

Computer or other means 52 is then used to determine a level for each key area of focus using any of the methods described above.

The individual levels determined for each key area are then combined using means 50 or other comparable means to assess the community capability. The combining may be performed as described above.

While there have been shown and described what are at present considered the preferred embodiments of the invention, it will be obvious to those skilled in the art that various changes and modifications may be made therein without departing from the scope of the invention as defined by the appended claims.

What is claimed is:

1. A method of assessing a community of practice capability, comprising the steps of:
providing a community of practice, of individuals;
providing a community model having key areas of focus wherein each said key area of focus is defined by levels, each level having attributes;
for each said key area of focus, comparing said community of individuals to said attributes to determine a community level for that key area of focus; and
combining the community levels to assess said community capability.

2. The method of claim 1, wherein said individuals are employees of a company.

3. The method of claim 1, wherein said key areas of focus are sponsorship, roles and responsibilities, membership, meaning and mastery, organizational memory, technology, social capital, activities, funding, value proposition, measurements, incentives, and vision/mission/goals.

4. The method of claim 1, wherein there are five numerical levels.

5. The method of claim 4, wherein said five numerical levels are also designated from one to five as potential, formation, building/evolving, operationalized/active, and adaptive.

6. The method of claim 1, wherein said community level for said key areas of focus is determined by said community matching the highest percentage of attributes for that model level.

7. The method of claim 1, wherein said community level for said key areas of focus is a non-integer numerical score based on a weighted average of community matching attributes for each model level.

8. The method of claim 1, wherein said community capability comprises a weighted average of said community levels for said key areas of focus.

9. A system for assessing a community of practice capability, comprising:
a community of practice, of individuals;
a community model having key areas of focus wherein each said key area of focus is defined by levels, each level having attributes;
for each said key area of focus, means for comparing said community of individuals to said attributes to determine a community level for that key area of focus; and
means for combining the community levels to assess said community capability.

10. The system of claim 9, wherein said individuals are employees of a company.

11. The system of claim 9, wherein said key areas of focus are sponsorship, roles and responsibilities, membership, meaning and mastery, organizational memory, technology, social capital; activities, funding, value proposition, measurements, incentives, and vision/mission/goals.

12. The system of claim 9, wherein there are five numerical levels.

13. The system of claim 12, wherein said five numerical levels are also designated from one to five as potential, formation, building/evolving, operationalized/active, and adaptive.

14. The system of claim 9, wherein said community level for said key areas of focus is determined by said community matching the highest percentage of attributes for that model level.

15. The system of claim 9, wherein said community level for said key areas of focus is a non-integer numerical score based on a weighted average of community matching attributes for each model level.

16. The system of claim 9, wherein said community capability comprises a weighted average of said community levels for said key areas of focus.

17. The system of claim 9, wherein said community level for said key area of focus is determined by computing a ratio of percentage matches for two levels having the highest percentage of attribute matches, and selecting a non-integer numerical value positioned between said two highest levels, with the same ratio.

18. The system of claim 11, wherein there are five numerical levels designated as potential, formation, building/evolving, operationalized/active, and adaptive, and wherein the attributes for the adaptive level of the activities key area of focus include first that the community jointly sponsors activities with other communities to leverage learning and knowledge sharing, and second that activities involving external clients and academics are designed and are occurring.
